(19) United States
(12) Patent Application Publication
(10) Pub. No.: US 2023/0156547 A1
(43) Pub. Date: May 18, 2023

(54) SWITCHING BETWEEN A DEFINED GENERATION OF STAND ALONE AND NON-STAND ALONE WIRELESS DEPLOYMENT BASED ON DETERMINED SERVICE REQUIREMENTS, NETWORK CAPABILITIES, AND USER EQUIPMENT CAPABILITIES

(71) Applicant: AT&T Intellectual Property I, L.P., Atlanta, GA (US)

(72) Inventors: Hongyan Lei, Plano, TX (US); Yupeng Jia, Austin, TX (US); Ye Chen, Marietta, GA (US); Wen Yang, Bellevue, WA (US)

(21) Appl. No.: 17/527,118

(22) Filed: Nov. 15, 2021

(51) Int. Cl. H04W 36/14; H04W 8/22

(52) U.S. Cl. CPC H04W 36/14; H04W 8/22

(57) ABSTRACT

Switching between a defined generation of stand-alone (SA) and non-stand-alone (NSA) wireless deployment is presented herein. A system determines user equipment (UE) communication capabilities of a UE that has been determined to be camped on an SA radio access network (RAN) equipment associated with a defined generation of deployment of network equipment, SA network equipment communication capabilities of the SA RAN equipment, and NSA network equipment communication capabilities of an NSA RAN equipment that is associated with the defined generation of deployment of network equipment and that has a defined NSA aggregated channel bandwidth that is greater than a defined SA aggregated channel bandwidth of the SA RAN equipment; and based on the communication capabilities of the UE, the SA RAN equipment, and the NSA RAN equipment, the system determines whether to initiate a handover of a communication session from the SA RAN equipment to the NSA RAN equipment.

### TECHNICAL FIELD

The subject disclosure generally relates to embodiments for switching between a defined generation (e.g., 5^{th} generation (5G)) of stand-alone (SA) and non-stand-alone (NSA) wireless deployment based on determined service requirements, network capabilities, and user equipment (UE) capabilities.

### BACKGROUND

Current generation, e.g., 5G SA, technologies offer new services such as network slicing and high bandwidth, low latency communications; however, limitations in deployment of 5G SA dedicated spectrum have led to lower 5G SA communication bandwidth compared with conventional wireless deployment technologies, e.g., 5G NSA. Further, many 5G SA mobile devices do not yet support full 5G SA capabilities—leading to reduced 5G SA wireless subscriber experiences. Consequently, conventional SA technologies have had some drawbacks, some of which are noted with reference to the various embodiments described herein below.

### BRIEF DESCRIPTION OF THE DRAWINGS

Non-limiting embodiments of the subject disclosure are described with reference to the following figures, wherein like reference numerals refer to like parts throughout the various views unless otherwise specified:

FIG. 1 illustrates a block diagram of a communication environment including an SA-NSA handover system for switching between a defined generation of SA and NSA wireless deployment based on determined service requirements, network capabilities, and UE capabilities, in accordance with various example embodiments;

FIG. 2 illustrates a block diagram of an SA-NSA handover system for switching between a defined generation of SA and NSA wireless deployment based on determined service requirements, network capabilities, and UE capabilities, in accordance with various example embodiments;

FIGS. 3-4 illustrate flow charts of a method associated with switching between a defined generation of SA and NSA wireless deployment based on determined service requirements, network capabilities, and UE capabilities, in accordance with various example embodiments;

FIG. 5 illustrates a flow chart of a method associated with receiving a request from a UE to switch a communication session from an SA RAN equipment to an NSA RAN equipment, in accordance with various example embodiments;

FIGS. 6-8 illustrate flow charts of a method associated with switching a communication session, corresponding to a call setup that has been performed by a UE, from an SA RAN equipment to an NSA RAN equipment, in accordance with various example embodiments;

FIG. 9 illustrates a flow chart of a method associated with receiving a request from a UE to initiate a handover of a communication session from an SA RAN equipment to an NSA RAN equipment, in accordance with various example embodiments; and

FIG. 10 is a block diagram representing an illustrative non-limiting computing system or operating environment in which one or more aspects of various embodiments described herein can be implemented for switching between a defined generation SA and NSA wireless deployment based on determined service requirements, network capabilities, and UE capabilities, in accordance with various example embodiments.

### DETAILED DESCRIPTION

Aspects of the subject disclosure will now be described more fully hereinafter with reference to the accompanying drawings in which example embodiments are shown. In the following description, for purposes of explanation, numerous specific details are set forth in order to provide a thorough understanding of the various embodiments. However, the subject disclosure may be embodied in many different forms and should not be construed as limited to the example embodiments set forth herein.

As described above, limitations in deployment of 5G SA dedicated spectrum have led to lower 5G SA communication bandwidth compared with conventional wireless deployment technologies; and many 5G SA mobile devices do not yet support full 5G SA capabilities. On the other hand, various embodiments disclosed herein can facilitate improved cellular subscriber experiences by switching between a defined generation (e.g., 5G) of SA and NSA wireless deployment based on determined service requirements, network capabilities, and UE capabilities.

For example, in embodiment(s), a system comprises a processor and a memory that stores executable instructions that, when executed by the processor, facilitate performance of operations by the processor—the operations comprising: determining user equipment (UE) communication capabilities corresponding to a UE that has been determined to be communicatively coupled, via a communication session, to an SA radio access network (RAN) equipment. The SA RAN equipment is associated with a defined generation (e.g., 5G) of deployment of network equipment and comprises SA network equipment communication capabilities including a first defined aggregated channel bandwidth corresponding to a first defined number of communication channels.

The operations further comprise: determining the SA network equipment communication capabilities of the SA RAN equipment, and determining NSA network equipment communication capabilities of NSA RAN equipment that is associated with the defined generation (e.g., 5G) of deployment of network equipment. In this regard, the NSA RAN equipment comprises NSA network equipment communication capabilities corresponding to a previously defined generation (e.g., 4G long term evolution (LTE)) of deployment of network equipment—the NSA network equipment communication capabilities comprising a second defined aggregated channel bandwidth corresponding to a second defined number of communication channels and being greater than the first defined aggregated channel bandwidth corresponding to the first defined number of communication channels of the SA network equipment communication capabilities.

In turn, the operations further comprise: based on the UE communication capabilities, the SA network equipment communication capabilities, and the NSA network equipment communication capabilities, determining whether to initiate a handover of the communication session from the SA RAN equipment to the NSA RAN equipment to facilitate providing, via the NSA RAN equipment using the second defined number of communication channels, portion(s) of the communication session to the UE.

In other embodiment(s), a method comprises: in response to determining that a UE has performed a call setup—corresponding to a data communication session—on an SA RAN equipment that comprises SA network equipment communication capabilities and that is associated with a defined generation (e.g., 5G) of deployment of network equipment, determining, by a system comprising a processor, UE communication capabilities corresponding to the UE, SA network equipment communication capabilities of the SA RAN equipment, and NSA network equipment communication capabilities of an NSA RAN equipment being associated with the defined generation of deployment of network equipment—NSA network equipment communication capabilities corresponding to a previously defined generation (e.g., 4G LTE) of deployment of network equipment.

In this regard, the SA network equipment communication capabilities comprise a first defined aggregated channel bandwidth corresponding to a first defined number of communication channels; and the NSA network equipment communication capabilities comprise a second defined aggregated channel bandwidth corresponding to a second defined number of communication channels—the second defined aggregated channel bandwidth being greater than the first defined aggregated channel bandwidth.

In turn, the method further comprises: based on the UE communication capabilities, the SA network equipment communication capabilities, and the NSA network equipment communication capabilities, determining whether a first estimate of a communication performance criterion corresponding to the second defined number of communication channels of the NSA RAN equipment and a second estimate of the communication performance criterion corresponding to the first defined number of communication channels of the SA RAN equipment satisfy a defined condition with respect to initiating a handover of the communication session from the SA RAN equipment to the NSA RAN equipment to facilitate providing, via the NSA RAN equipment using the second defined number of communication channels, portion(s) of the communication session to the UE.

In yet other embodiment(s), a non-transitory machine-readable medium, comprises executable instructions that, when executed by a system comprising a processor, facilitate performance of operations, comprising: in response to a UE being determined to be camped on an SA RAN equipment corresponding to a defined generation of wireless deployment of network equipment, determining UE communication capabilities of the UE, SA RAN equipment communication capabilities of the SA RAN equipment, and NSA RAN equipment communication capabilities of an NSA RAN equipment corresponding to the defined generation of wireless deployment of network equipment, in which the NSA RAN equipment communication capabilities correspond to a previously defined generation of wireless deployment of network equipment comprising a first aggregated bandwidth of a first group of communication channels of the NSA RAN equipment that is greater than a second aggregated bandwidth of a second group of communication channels of the SA RAN equipment.

The operations further comprise: based on the UE communication capabilities, the SA RAN equipment communication capabilities, and the NSA RAN equipment communication capabilities, determining whether to initiate a handover of a communication session from the SA RAN equipment to the NSA RAN equipment to facilitate providing, via the NSA RAN equipment using the first aggregated bandwidth of the first group of communication channels of the NSA RAN equipment that is greater than the second aggregated bandwidth of the second group of communication channels of the SA RAN equipment, at least a portion of the communication session to the UE.

Reference throughout this specification to “one embodiment,” “an embodiment,” etc. means that a particular feature, structure, or characteristic described in connection with the embodiment is included in at least one embodiment. Thus, the appearances of the phrase “in one embodiment,” “in an embodiment,” etc. in various places throughout this specification are not necessarily all referring to the same embodiment. Furthermore, the particular features, structures, or characteristics may be combined in any suitable manner in one or more embodiments.

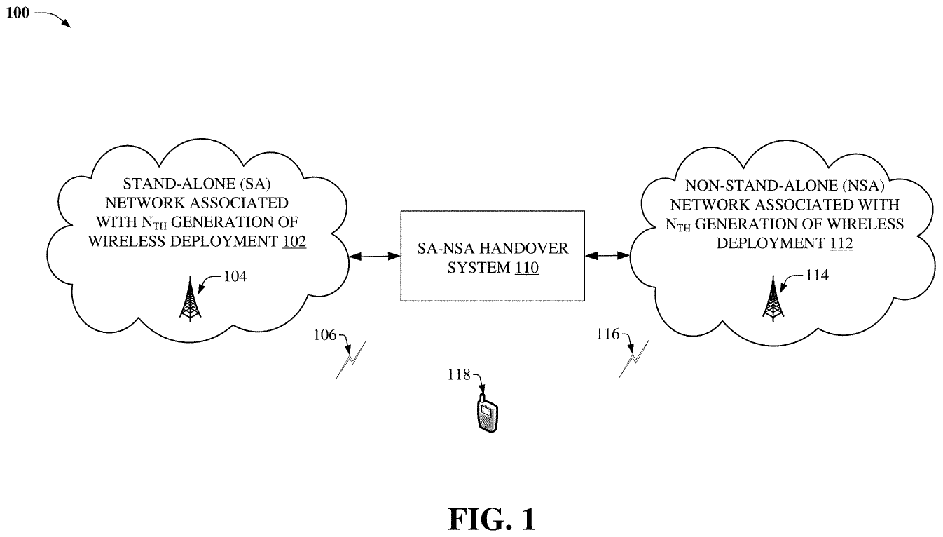

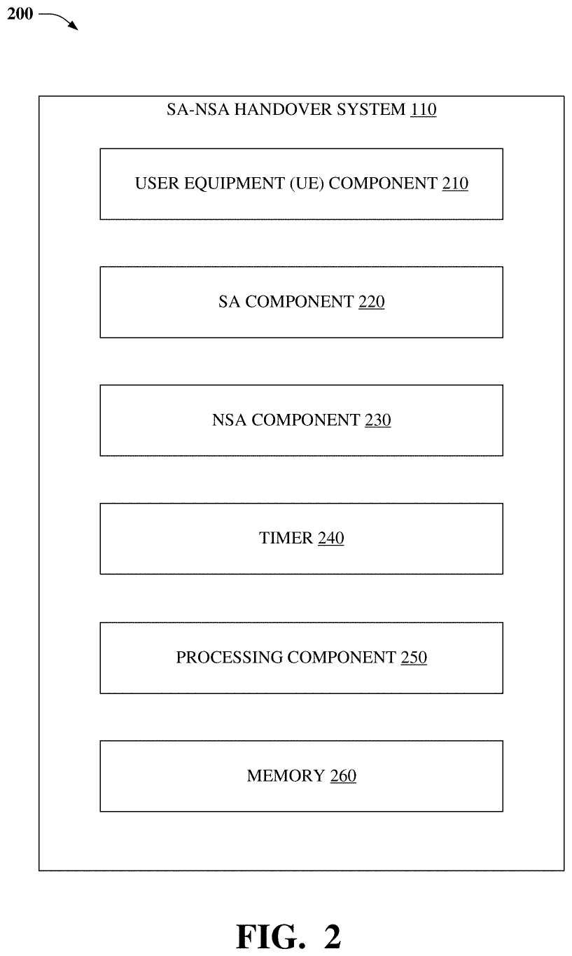

Referring now to FIGS. 1-2, an SA-NSA handover system (110) can facilitate switching between a defined generation of SA and NSA wireless deployment based on determined service requirements, network capabilities, and UE capabilities, in accordance with various example embodiments. As illustrated by FIG. 1, SA RAN equipment (104) of an SA network (102) is associated with a defined (e.g., Nₜh) generation (e.g., 5G) of deployment of network equipment, and includes SA network equipment communication capabilities including an available aggregated/combined communication channel bandwidth (e.g., a first defined aggregated channel bandwidth) corresponding to a group of communication channels, e.g., of the SA RAN equipment.

Further, NSA RAN equipment (114) is also associated with the defined generation (e.g., 5G) of deployment of network equipment, and includes NSA network equipment communication capabilities corresponding to a previously defined generation (e.g., 4G LTE) of deployment of network equipment that includes an available aggregated/combined communication channel bandwidth (e.g., a second defined aggregated channel bandwidth) corresponding to a group of communication channels, e.g., of the NSA RAN equipment—the second defined aggregated channel bandwidth being greater than the first defined aggregated channel bandwidth.

As illustrated by FIG. 2, the SA-NSA handover system includes a UE component (210), an SA component (220), an NSA component (230), a timer (240), a processing component (250), and a memory (260). In embodiment(s), the SA-NSA handover system can determine whether a UE (118) is communicatively coupled to, e.g., camped on, the SA RAN equipment, e.g., via communication session(s) between the UE and the SA RAN equipment.

In embodiment(s), the SA-NSA handover system can determine, e.g., via a query that has been sent by the SA-NSA handover system, e.g., to a device, equipment (e.g., 104), or other component of the SA network, whether the UE is communicatively coupled, e.g., camped on, the SA RAN equipment.

In other embodiment(s), the SA-NSA handover system can determine whether the UE has performed (e.g., via the SA RAN equipment) a call setup within/on the SA network—the call setup corresponding to a call, data communication session, or similar data transfer request that has been initiated by the UE. In an embodiment, the SA-NSA handover system can determine whether the UE has performed the call setup by receiving, e.g., via the SA RAN, a message indicating that the UE has performed the call setup.

In this regard, in embodiment(s), in response to determining that the UE is communicatively coupled, e.g., camped on, the SA RAN equipment, and/or in response to determining that the call setup has been performed within/on the SA network, the UE component determines UE communication capabilities of the UE, the SA component determines SA network equipment communication capabilities of the SA RAN equipment, and the NSA component determines NSA network equipment communication capabilities of the NSA RAN equipment.

In embodiment(s), the UE communication capabilities represent/define that the UE utilize the SA RAN equipment or the NSA RAN equipment for the data communication session.

In other embodiment(s), the UE communication capabilities represent/define battery performance requirements of the UE, e.g., representing that a determined battery life of a battery of the UE is below a defined minimum battery life required to permit handover of the data communication session from the SA RAN equipment to the NSA RAN equipment, and to further facilitate performance of the data communication session via the NSA RAN equipment.

In this regard, in response to determining, based on the UE communication capabilities, that power of the UE is to be conserved, the SA-NSA handover system can facilitate conservation of power of the UE by preventing inter-radio access technology (IRAT) mobility corresponding to a handover of the data communication session from the SA RAN equipment to the NSA RAN equipment, e.g., the IRAT mobility and/or handover(s) of respective communication sessions consuming extra power of the UE compared to power consumed by the UE when operating via the SA RAN equipment without the IRAT mobility and/or handover(s) being performed.

In yet other embodiment(s), the UE communication capabilities represent/define subscriber preferences of a subscriber identity corresponding to the UE, e.g., of a subscriber of the communication service. In this regard, the subscriber preferences define that the UE utilize the SA RAN equipment or the NSA RAN equipment for the data communication session.

In embodiment(s), the UE communication capabilities represent/define application performance requirements of an application that is to be executed on the UE, the application including, e.g., a video streaming application; a network “speed test” application used to determine a speed of data transmission/reception of a communication service; a gaming application; or similar application that requires a defined minimum communication bandwidth, e.g., for more than a defined transmission duration (e.g., greater than 1 minute).

In this regard, in response to determining, based on the UE communication capabilities, that the application performance requirements of the application represent that the application requires the defined minimum communication bandwidth, and in response to determining that the defined minimum communication bandwidth is greater than the first defined aggregated channel bandwidth of the SA RAN equipment, and that the defined minimum communication bandwidth is less than or equal to the second defined aggregated channel bandwidth of the NSA RAN equipment, the SA-NSA handover system can initiate a handover of the data communication session from the SA RAN equipment to the NSA RAN equipment.

In other embodiment(s), the SA network equipment communication capabilities of the SA RAN equipment include a first estimated/determined rate of data transfer corresponding to the first defined number of communication channels of the SA RAN equipment; a first estimated/determined data latency corresponding to the first defined number of communication channels of the SA RAN equipment; a first estimated/determined jitter corresponding to the first defined number of communication channels of the SA RAN equipment; and/or a first estimated/determined reliability of communication service corresponding to the first defined number of communication channels of the SA RAN equipment.

Further, the NSA network equipment communication capabilities of the NSA RAN equipment include a second estimated/determined rate of data transfer corresponding to the second defined number of communication channels of the NSA RAN equipment; a second estimated/determined data latency corresponding to the second defined number of communication channels of the NSA RAN equipment; a second estimated/determined jitter corresponding to the second defined number of communication channels of the NSA RAN equipment; and/or a second estimated/determined reliability of communication service corresponding to the second defined number of communication channels of the NSA RAN equipment.

In this regard, in embodiment(s), in response to determining that the second estimated/determined rate of data transfer corresponding to the second defined number of communication channels of the NSA RAN equipment is greater than the first estimated/determined rate of data transfer corresponding to the first defined number of communication channels of the SA RAN equipment, the SA-NSA handover system can initiate the handover of the data communication session from the SA RAN equipment to the NSA RAN equipment.

In other embodiment(s), in response to determining that the second estimated/determined data latency corresponding to the second defined number of communication channels of the NSA RAN equipment is less than the first estimated/determined data latency corresponding to the first defined number of communication channels of the SA RAN equipment, the SA-NSA handover system can initiate the handover of the data communication session from the SA RAN equipment to the NSA RAN equipment.

In yet other embodiment(s), in response to determining that the second estimated/determined jitter corresponding to the second defined number of communication channels of the NSA RAN equipment is less than the first estimated/determined jitter corresponding to the first defined number of communication channels of the SA RAN equipment, the SA-NSA handover system can initiate the handover of the data communication session from the SA RAN equipment to the NSA RAN equipment.

In embodiment(s), in response to determining that the second estimated/determined reliability of communication service corresponding to the second defined number of communication channels of the NSA RAN equipment is greater than the first estimated/determined reliability of communication service corresponding to the first defined number of communication channels of the SA RAN equipment, the SA-NSA handover system can initiate the handover of the data communication session from the SA RAN equipment to the NSA RAN equipment.

It should be appreciated by a person of ordinary skill in the art of wireless communication(s) having the benefit of the instant disclosure that the SA-NSA handover system can determine whether to initiate the handover of the communication session from the SA RAN equipment to the NSA RAN equipment based on the UE communication capabilities, the SA network equipment communication capabilities, and/or the NSA network equipment communication capabilities, e.g., in any combination of determination(s) of such capabilities as described above.

In other embodiment(s), a group of defined communication preferences, e.g., represented by the UE communication capabilities, the SA network equipment communication capabilities, and/or the NSA network equipment communication capabilities, comprises a defined type of UE (e.g., representing whether the UE is operable via the SA RAN equipment and/or the NSA RAN equipment), a defined type of data traffic (e.g., representing whether such traffic is operable via the SA RAN and/or the NSA RAN, e.g., based on a defined minimum communication bandwidth), and/or a defined type of service (e.g., representing whether the service corresponds to the defined type of data traffic and/or the defined minimum communication bandwidth.

In turn, the SA-NSA handover system can determine, based on the group of defined communication preferences, whether to initiate the handover of the data communication session from the SA RAN equipment to the NSA RAN equipment.

In yet other embodiment(s), in response to determining to initiate the handover of the data communication session from the SA RAN equipment to the NSA RAN equipment, the SA-NSA handover system can start, e.g., initiate counting of processing cycles, e.g., while the UE is camped on the SA RAN equipment or during the communication session, the timer (240)—in which the timer has been set to expire after a defined period of time represented by a defined number of processing cycles of the SA-NSA handover system.

Further, in response to determining, after expiration of the timer, that the communication session has not ended, the SA-NSA handover system can initiate the handover of the communication session from the SA RAN equipment to the NSA RAN equipment.

In turn, in response to the communication session being determined to be completed via the NSA RAN equipment, the SA-NSA handover system can send an instruction to the UE directing the UE to camp on, e.g., return to, the SA RAN equipment, e.g., directing the UE to be communicatively coupled to the SA RAN equipment to facilitate servicing, via the SA RAN equipment, of other communication session(s), e.g., call(s), corresponding to the UE.

In embodiment(s), in response to receiving, from the UE, a request to initiate a handover of the communication session from the SA RAN equipment to the NSA RAN equipment, the SA-NSA handover system can initiate the handover. Further, in response to the communication session being determined, via the NSA RAN equipment, to be completed, the SA-NSA handover system can send an instruction to the UE directing the UE to camp on, e.g., return to, the SA RAN equipment, e.g., directing the UE to be communicatively coupled to the SA RAN equipment to facilitate servicing, via the SA RAN equipment, of other communication session(s), e.g., call(s), corresponding to the UE.

In other embodiment(s), the UE can determine the UE communication capabilities, e.g., representing a remaining battery life of the UE, subscriber equipment settings of the UE that have been configured by a subscriber identity corresponding to the UE, and/or application performance requirements of an application that is to be executed by the UE. In turn, in response to determining, based on the UE communication capabilities, that a handover from the SA RAN equipment to the NSA RAN equipment should be performed, the UE can send, to the SA-NSA handover system, the request to initiate the handover from the SA RAN equipment to the NSA RAN equipment.

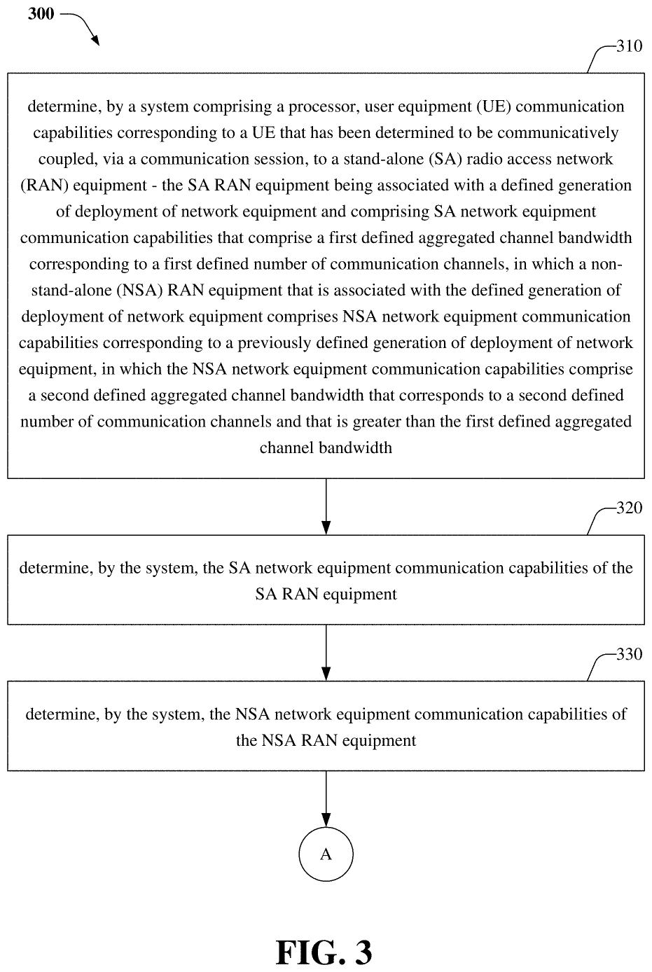

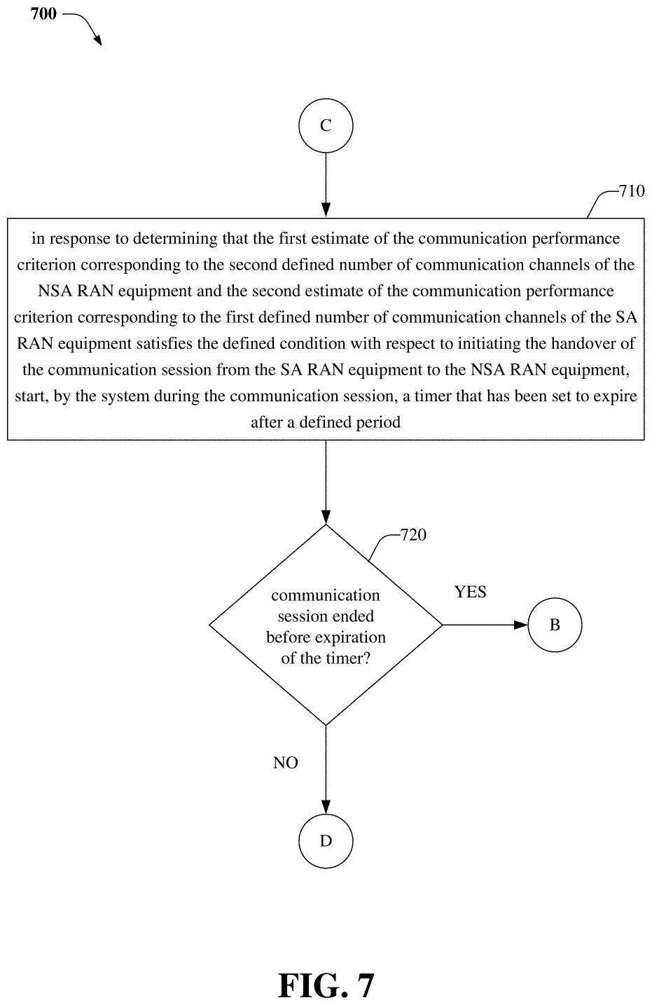

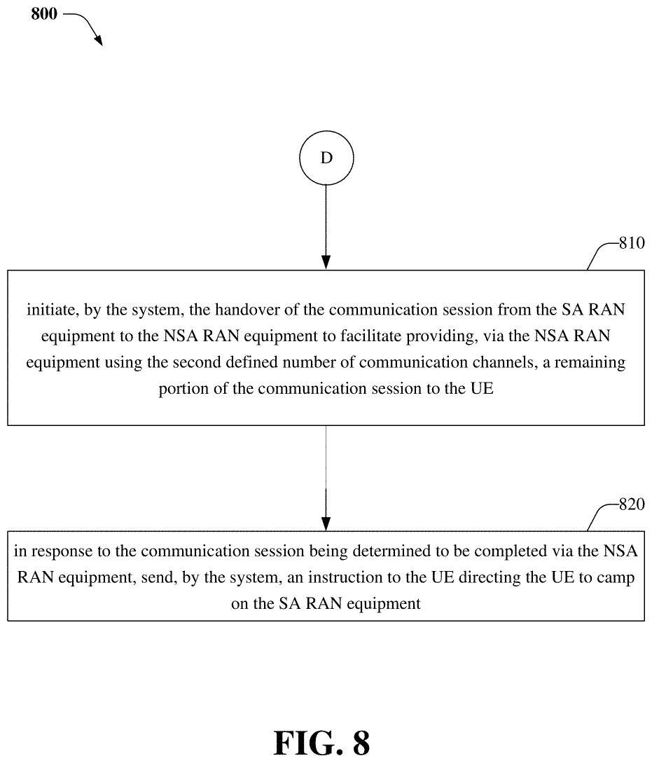

FIGS. 3-9 illustrate methodologies in accordance with the disclosed subject matter. For simplicity of explanation, the methodologies are depicted and described as a series of acts. It is to be understood and appreciated that various embodiments disclosed herein are not limited by the acts illustrated and/or by the order of acts. For example, acts can occur in various orders and/or concurrently, and with other acts not presented or described herein. Furthermore, not all illustrated acts may be required to implement the methodologies in accordance with the disclosed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

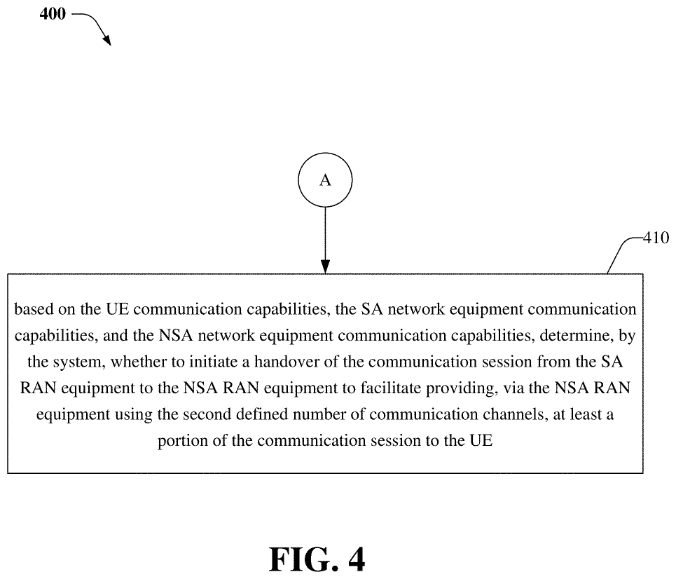

Referring now to FIGS. 3-4, flow charts (300-400) of a method associated with switching between a defined generation of SA and NSA wireless deployment based on determined service requirements, network capabilities, and UE capabilities, are illustrated, in accordance with various example embodiments. At 310, a system (e.g., 110) determines UE communication capabilities corresponding to a UE that has been determined to be communicatively coupled, via a communication session, to an SA RAN equipment—the SA RAN equipment being associated with a defined generation (e.g., 5G) of deployment of network equipment and comprising SA network equipment communication capabilities that comprise a first defined aggregated channel bandwidth corresponding to a first defined number of communication channels, in which an NSA RAN equipment that is associated with the defined generation of deployment of network equipment comprises NSA network equipment communication capabilities corresponding to a previously defined generation (e.g., 4G LTE) of deployment of network equipment, in which the NSA network equipment communication capabilities comprise a second defined aggregated channel bandwidth that corresponds to a second defined number of communication channels, and in which the second defined aggregated channel bandwidth is greater than the first defined aggregated channel bandwidth.

In turn, the system determines (at 320) the SA network equipment communication capabilities of the SA RAN equipment, and the system determines (at 330) the NSA network equipment communication capabilities of the NSA RAN equipment.

In turn, at 410, based on the UE communication capabilities, the SA network equipment communication capabilities, and the NSA network equipment communication capabilities, the system determines whether to initiate a handover of the communication session from the SA RAN equipment to the NSA RAN equipment to facilitate providing, via the NSA RAN equipment using the second defined number of communication channels, at least a portion of the communication session to the UE.

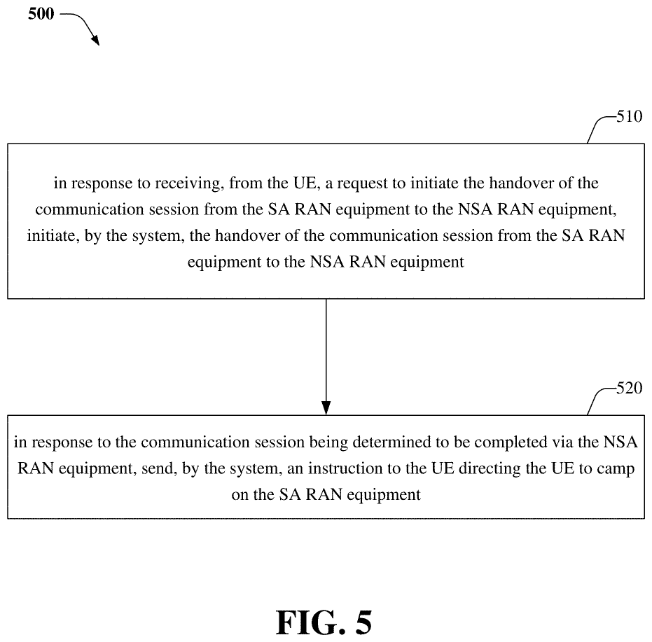

FIG. 5 illustrates a flow chart (500) of a method associated with receiving a request from a UE to switch a communication session from an SA RAN equipment to an NSA RAN equipment, in accordance with various example embodiments. At 510, in response to receiving, from the UE, a request to initiate the handover of the communication session from the SA RAN equipment to the NSA RAN equipment, the system initiates the handover of the communication session from the SA RAN equipment to the NSA RAN equipment.

At 520, in response to the communication session being determined to be completed via the NSA RAN equipment, the system sends an instruction to the UE directing the UE to camp on, e.g., return to, the SA RAN equipment, e.g., directing the UE to be communicatively coupled to the SA RAN equipment to facilitate servicing, via the SA RAN equipment, of other communication session(s), e.g., call(s), corresponding to the UE.

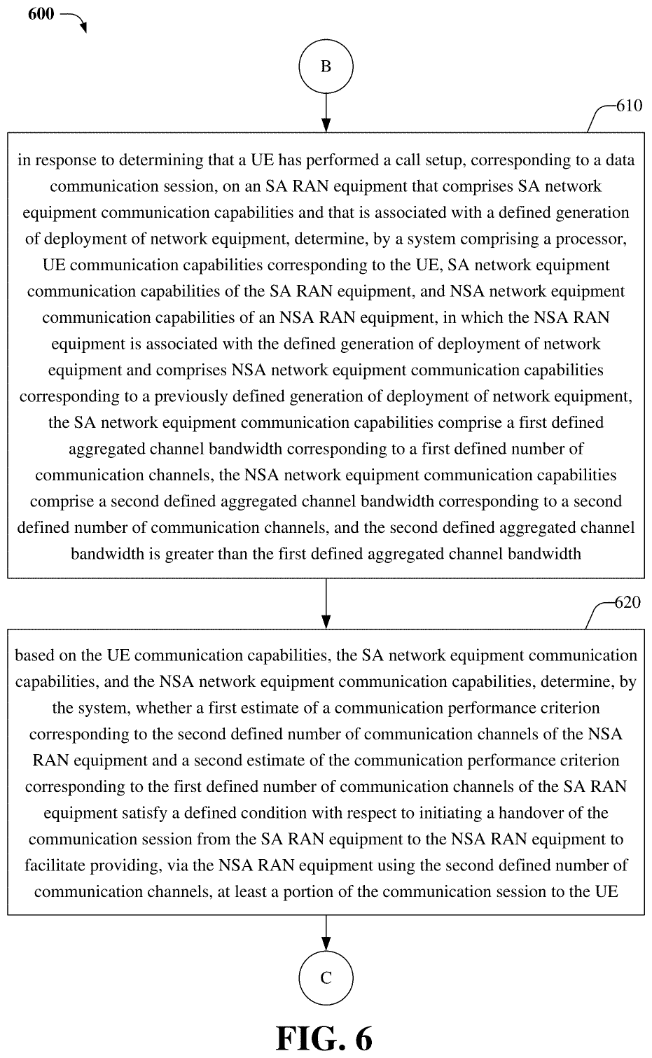

FIGS. 6-8 illustrate flow charts (600-800) of a method associated with switching a communication session, corresponding to a call setup that has been performed by a UE, from an SA RAN equipment to an NSA RAN equipment, in accordance with various example embodiments. At 610, in response to determining that a UE has performed a call setup, corresponding to a data communication session, on an SA RAN equipment that comprises SA network equipment communication capabilities and that is associated with a defined generation (e.g., 5G) of deployment of network equipment, a system (e.g., 110) determines UE communication capabilities corresponding to the UE, SA network equipment communication capabilities of the SA RAN equipment, and NSA network equipment communication capabilities of the NSA RAN equipment, in which the NSA RAN equipment is associated with the defined generation of deployment of network equipment and comprises NSA network equipment communication capabilities corresponding to a previously defined generation (e.g., 4G LTE) of deployment of network equipment, the SA network equipment communication capabilities comprise a first defined aggregated channel bandwidth corresponding to a first defined number of communication channels, the NSA network equipment communication capabilities comprise a second defined aggregated channel bandwidth corresponding to a second defined number of communication channels, and the second defined aggregated channel bandwidth is greater than the first defined aggregated channel bandwidth.

At 620, based on the UE communication capabilities, the SA network equipment communication capabilities, and the NSA network equipment communication capabilities, the system determines whether a first estimate of a communication performance criterion corresponding to the second defined number of communication channels of the NSA RAN equipment and a second estimate of the communication performance criterion corresponding to the first defined number of communication channels of the SA RAN equipment satisfy a defined condition with respect to initiating a handover of the communication session from the SA RAN equipment to the NSA RAN equipment to facilitate providing, via the NSA RAN equipment using the second defined number of communication channels, at least a portion of the communication session to the UE.

At 710, in response to determining that the first estimate of the communication performance criterion corresponding to the second defined number of communication channels of the NSA RAN equipment and the second estimate of the communication performance criterion corresponding to the first defined number of communication channels of the SA RAN equipment satisfies the defined condition with respect to initiating the handover of the communication session from the SA RAN equipment to the NSA RAN equipment, the system starts, during the communication session, a timer that has been set to expire after a defined period.

At 720, the system can determine whether the communication session ended before expiration of the timer. In this regard, in response to a determination that the communication session ended before expiration of the timer, flow returns to 610; otherwise, flow continues to 810, at which the system initiates the handover of the communication session from the SA RAN equipment to the NSA RAN equipment to facilitate providing, via the NSA RAN equipment using the second defined number of communication channels, a remaining portion of the communication session to the UE.

At 820, in response to the communication session being determined to be completed via the NSA RAN equipment, the system sends an instruction to the UE directing the UE to camp on, e.g., return to, the SA RAN equipment, e.g., directing the UE to be communicatively coupled to the SA RAN equipment to facilitate servicing, via the SA RAN equipment, of other communication session(s), e.g., call(s), corresponding to the UE.

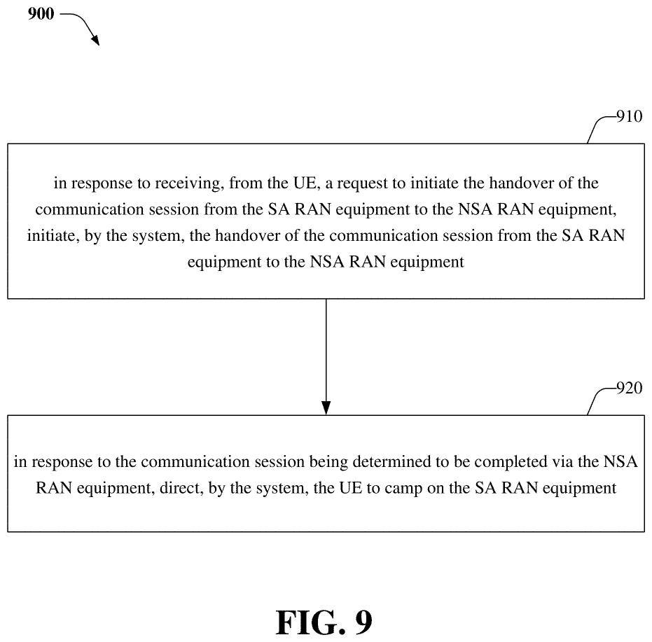

FIG. 9 illustrates a flow chart (900) of a method associated with receiving a request from a UE to initiate a handover of a communication session from an SA RAN equipment to an NSA RAN equipment, in accordance with various example embodiments. At 910, in response to receiving, from the UE, a request to initiate the handover of the communication session from the SA RAN equipment to the NSA RAN equipment, the system initiates the handover of the communication session from the SA RAN equipment to the NSA RAN equipment.

As it employed in the subject specification, the term “processor”, “processing component”, or other terms referencing a processing device can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor may also be implemented as a combination of computing processing units.

In the subject specification, terms such as “memory component”, “memory”, “memory storage”, “system memory”, “data storage”, “storage device”, and substantially any other information storage component relevant to operation and functionality of a component and/or process, refer to “memory components,” or entities embodied in a “memory,” or components comprising the memory. It will be appreciated that the memory components described herein can be either volatile memory or nonvolatile memory, or can include both volatile and nonvolatile memory.

By way of illustration, and not limitation, nonvolatile memory, for example, can be included in SA-NSA handover system 110, memory 260, system memory 1006 (see below), external storage 1016 (see below), and/or memory storage 1052 (see below). Further, nonvolatile memory can be included in read only memory (ROM), programmable ROM (PROM), electrically programmable ROM (EPROM), electrically erasable ROM (EEPROM), or flash memory. Volatile memory (e.g., 1012) can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

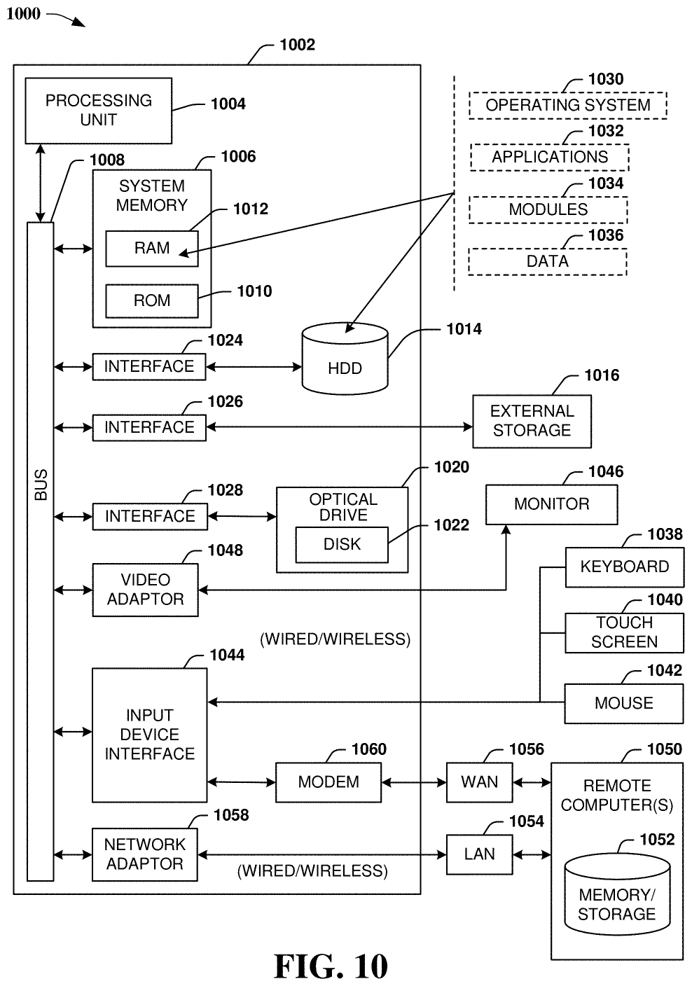

In order to provide additional context for various embodiments described herein, FIG. 10 and the following discussion are intended to provide a brief, general description of a suitable computing environment 1000 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that in various embodiments, methods disclosed herein can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Wi-Fi allows connection to the Internet from a desired location (e.g., a vehicle, couch at home, a bed in a hotel room, or a conference room at work, etc.) without wires. Wi-Fi is a wireless technology similar to that used in a cell phone that enables such devices, e.g., mobile phones, computers, etc., to send and receive data indoors and out, anywhere within the range of a base station. Wi-Fi networks use radio technologies called IEEE 802.11 (a, b, g, etc.) to provide secure, reliable, fast wireless connectivity. A Wi-Fi network can be used to connect devices (e.g., mobile phones, computers, etc.) to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

As utilized herein, terms “component,” “system,” “server,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Aspects of systems, apparatus, and processes explained herein can constitute machine-executable instructions embodied within a machine, e.g., embodied in a computer readable medium (or media) associated with the machine. Such instructions, when executed by the machine, can cause the machine to perform the operations described. Additionally, systems, processes, process blocks, etc. can be embodied within hardware, such as an application specific integrated circuit (ASIC) or the like. Moreover, the order in which some or all of the process blocks appear in each process should not be deemed limiting. Rather, it should be understood by a person of ordinary skill in the art having the benefit of the instant disclosure that some of the process blocks can be executed in a variety of orders not illustrated.

Further, components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components.

Further, aspects, features, and/or advantages of the disclosed subject matter can be exploited in substantially any wireless telecommunication or radio technology, e.g., IEEE 802.XX technology, e.g., Wi-Fi, Bluetooth, etc.; WiMAX; enhanced GPRS; 3GPP LTE; 3GPP2; UMB; 3GPP UMTS; HSPA; high speed downlink packet access (HSDPA); high speed uplink packet access (HSUPA); LTE-A, GSM, NFC, Wibree, Zigbee, satellite, Wi-Fi Direct, etc.

In addition, selections of a radio technology, or radio access technology, can include second generation (2G), third generation (3G), fourth generation (4G LTE), fifth generation (5G), x^{th} generation, etc. evolution of the radio access technology; however, such selections are not intended as a limitation of the disclosed subject matter and related aspects thereof. Further, aspects, features, and/or advantages of the disclosed subject matter can be exploited in disparate electromagnetic frequency bands. Moreover, one or more embodiments described herein can be executed in one or more network elements, and/or within one or more elements of a network infrastructure, e.g., radio network controller, wireless access point (AP), etc.

Moreover, terms like “mobile device,” “user equipment,” “mobile station,” “mobile subscriber station,” “access terminal,” “terminal”, “handset,” “appliance,” “machine,” “wireless communication device,” “cellular phone,” “personal digital assistant,” “smartphone,” “wireless device”, and similar terminology refer to a wireless device, or wireless communication device, which is at least one of (1) utilized by a subscriber of a wireless service, or communication service, to receive and/or convey data associated with voice, video, sound, and/or substantially any data-stream or signaling-stream; or (2) utilized by a subscriber of a voice over IP (VoIP) service that delivers voice communications over IP networks such as the Internet or other packet-switched networks. Further, the foregoing terms are utilized interchangeably in the subject specification and related drawings.

A communication environment, e.g., 100, for systems, methods, and/or apparatus disclosed herein can include any suitable mobile and/or wireline-based circuit-switched communication network including a GSM network, a time division multiple access (TDMA) network, a code division multiple access (CDMA) network, such as an Interim Standard 95 (IS-95) and subsequent iterations of CDMA technology, an integrated digital enhanced network (iDEN) network and a PSTN. Further, examples of the communication network can include any suitable data packet-switched or combination data packet/circuit-switched communication network, wired or wireless IP network such as a VoLTE network, a VoIP network, an IP data network, a UMTS network, a GPRS network, or other communication networks that provide streaming data communication over IP and/or integrated voice and data communication over combination data packet/circuit-switched technologies.

Similarly, one of ordinary skill in the art will appreciate that a wireless device, e.g., a wireless communication device, a user equipment, etc. for systems, methods, and/or apparatus disclosed herein can include a mobile device, a mobile phone, a 4G LTE, a 5G, etc. cellular communication device, a PSTN phone, a cellular communication device, a cellular phone, a satellite communication device, a satellite phone, a VoIP phone, WiFi phone, a dual-mode cellular/WiFi phone, a combination cellular/VoIP/WiFi/WiMAX phone, a portable computer, or any suitable combination thereof. Specific examples of a wireless system can include, but are not limited to, a cellular device, such as a GSM, TDMA, CDMA, IS-95 and/or iDEN phone, a cellular/WiFi device, such as a dual-mode GSM, TDMA, IS-95 and/or iDEN/VoIP phones, UMTS phones, UMTS VoIP phones, or like devices or combinations thereof.

The disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, magnetic storage devices, e.g., hard disk; floppy disk; magnetic strip(s); optical disk (e.g., compact disk (CD), digital video disc (DVD), Blu-ray Disc (BD)); smart card(s); and flash memory device(s) (e.g., card, stick, key drive); and/or a virtual device that emulates a storage device and/or any of the above computer-readable media.

In accordance with various aspects of the subject specification, artificial intelligence based systems, components, etc. can employ classifier(s) that are explicitly trained, e.g., via a generic training data, as well as implicitly trained, e.g., via observing characteristics of communication equipment, e.g., a RAN equipment, a gateway, a wireless communication device, a UE, etc., by receiving reports from such communication equipment, by receiving operator preferences, by receiving historical information, by receiving extrinsic information, etc.

For example, support vector machines can be configured via a learning or training phase within a classifier constructor and feature selection module, component, etc. Thus, the classifier(s) can be used by an artificial intelligence system to automatically learn and perform a number of functions, e.g., performed by a system (e.g., 110), including, but not limited to, in response to a UE being determined to be camped on an SA RAN equipment corresponding to a defined generation (e.g., 5G) of wireless deployment of network equipment, determining UE communication capabilities of the UE, SA RAN equipment communication capabilities of the SA RAN equipment, and NSA RAN equipment communication capabilities of an NSA RAN equipment corresponding to the defined generation of wireless deployment of network equipment, in which the NSA RAN equipment communication capabilities correspond to a previously defined generation (e.g., 4G LTE) of wireless deployment of network equipment comprising a first aggregated bandwidth of a first group of communication channels of the NSA RAN equipment that is greater than a second aggregated bandwidth of a second group of communication channels of the SA RAN equipment; and based on the UE communication capabilities, the SA RAN equipment communication capabilities, and the NSA RAN equipment communication capabilities, determining whether to initiate a handover of a communication session from the SA RAN equipment to the NSA RAN equipment to facilitate providing, via the NSA RAN equipment using the first aggregated bandwidth of the first group of communication channels of the NSA RAN equipment that is greater than the second aggregated bandwidth of the second group of communication channels of the SA RAN equipment, at least a portion of the communication session to the UE.

A classifier can be a function that maps an input attribute vector, x=(x1, x2, x3, x4, xn), to a confidence that the input belongs to a class, that is, f(x)=confidence (class). Such classification can employ a probabilistic and/or statistical-based analysis (e.g., factoring into the analysis utilities and costs) to infer an action that a user, e.g., subscriber, desires to be automatically performed. In the case of communication systems, for example, attributes can be information received from access points, services, components of a wireless communication network, etc., and the classes can be categories or areas of interest (e.g., levels of priorities). A support vector machine is an example of a classifier that can be employed. The support vector machine operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein can also be inclusive of statistical regression that is utilized to develop models of priority.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., a decision tree based learning model, a linear regression based learning model, support vector machines, neural networks, expert systems, Bayesian belief networks, fuzzy logic, and data fusion engines) can be employed in connection with performing automatic and/or inferred action in connection with the disclosed subject matter.

Further, the word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art having the benefit of the instant disclosure.

Furthermore, to the extent that the terms “includes,” “has,” “contains,” and other similar words are used in either the detailed description or the appended claims, such terms are intended to be inclusive—in a manner similar to the term “comprising” as an open transition word—without precluding any additional or other elements. Moreover, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, comprising:
a processor; and
a memory that stores executable instructions that, when executed by the processor, facilitate performance of operations by the processor, comprising:
determining user equipment communication capabilities corresponding to a user equipment that has been determined to be communicatively coupled, via a communication session, to a stand-alone radio access network equipment, wherein the stand-alone radio access network equipment comprises stand-alone network equipment communication capabilities and is associated with a defined generation of deployment of network equipment, wherein the stand-alone network equipment communication capabilities comprise a first defined aggregated channel bandwidth corresponding to a first defined number of communication channels, wherein a non-stand-alone radio access network equipment that is associated with the defined generation of deployment of network equipment comprises non-stand-alone network equipment communication capabilities corresponding to a previously defined generation of deployment of network equipment, wherein the non-stand-alone network equipment communication capabilities comprise a second defined aggregated channel bandwidth corresponding to a second defined number of communication channels, and wherein the second defined aggregated channel bandwidth is greater than the first defined aggregated channel bandwidth;
determining the stand-alone network equipment communication capabilities of the stand-alone radio access network equipment;
determining the non-stand-alone network equipment communication capabilities of the non-stand-alone radio access network equipment; and
based on the user equipment communication capabilities, the stand-alone network equipment communication capabilities, and the non-stand-alone network equipment communication capabilities, determining whether to initiate a handover of the communication session from the stand-alone radio access network equipment to the non-stand-alone radio access network equipment to facilitate providing, via the non-stand-alone radio access network equipment using the second defined number of communication channels, at least a portion of the communication session to the user equipment.

2. The system of claim 1, wherein the operations further comprise:
in response to determining to initiate the handover, starting, during the communication session, a timer that has been set to expire after a defined period;
in response to determining, after expiration of the timer, that the communication session has not ended, initiating the handover of the communication session from the stand-alone radio access network equipment to the non-stand-alone radio access network equipment to facilitate providing, via the non-stand-alone radio access network equipment using the second defined number of communication channels, a remaining portion of the communication session to the user equipment; and
in response to the communication session being determined to be completed via the non-stand-alone radio access network equipment, sending an instruction to the user equipment directing the user equipment to camp on the stand-alone radio access network equipment.

3. The system of claim 1, wherein determining whether to initiate the handover comprises:
determining whether a first estimated rate of data transfer corresponding to the second defined number of communication channels of the non-stand-alone radio access network equipment is greater than a second estimated rate of data transfer corresponding to the first defined number of communication channels of the stand-alone radio access network equipment.

4. The system of claim 1, wherein determining whether to initiate the handover comprises:
determining whether a first estimated data latency corresponding to the second defined number of communication channels of the non-stand-alone radio access network equipment is less than a second estimated data latency corresponding to the first defined number of communication channels of the stand-alone radio access network equipment.

5. The system of claim 1, wherein determining whether to initiate the handover comprises:
determining whether a first estimated jitter corresponding to the second defined number of communication channels of the non-stand-alone radio access network equipment is less than a second estimated jitter corresponding to the first defined number of communication channels of the stand-alone radio access network equipment.

6. The system of claim 1, wherein determining whether to initiate the handover comprises:
determining whether a first estimated reliability of communication service corresponding to the second defined number of communication channels of the non-stand-alone radio access network equipment is greater than a second estimated reliability of service corresponding to the first defined number of communication channels of the stand-alone radio access network equipment.

7. The system of claim 1, wherein determining whether to initiate the handover comprises:
determining, during a call setup of the user equipment that has been initiated on the stand-alone radio access network equipment, whether to initiate the handover of the communication session from the stand-alone radio access network equipment to the non-stand-alone radio access network equipment.

8. The system of claim 7, wherein determining, during the call setup, whether to initiate the handover comprises:
based on a group of defined communication preferences comprising at least one of a defined type of user equipment, a defined type of data traffic, or a defined type of service, determining whether to initiate the handover of the communication session from the stand-alone radio access network equipment to the non-stand-alone radio access network equipment.

9. The system of claim 1, wherein determining whether to initiate the handover comprises:
in response to receiving, from the user equipment, a request to initiate the handover of the communication session from the stand-alone radio access network equipment to the non-stand-alone radio access network equipment, initiating the handover of the communication session from the stand-alone radio access network equipment to the non-stand-alone radio access network equipment; and
in response to the communication session being determined to be completed via the non-stand-alone radio access network equipment, sending an instruction to the user equipment directing the user equipment to camp on the stand-alone radio access network equipment.

10. The system of claim 9, wherein receiving the request to initiate the handover further comprises:
in response to a determination of at least one of a battery life of the user equipment, subscriber equipment settings of the user equipment that have been configured by a subscriber identity corresponding to the user equipment, or application performance requirements of an application that is to be executed by the user equipment, receiving, from the user equipment, the request to initiate the handover of the communication session from the stand-alone radio access network equipment to the non-stand-alone radio access network equipment.

11. The system of claim 1, wherein the user equipment communication capabilities define that the user equipment utilize the stand-alone radio access network equipment or the non-stand-alone radio access network equipment.

12. The system of claim 1, wherein the user equipment communication capabilities represent at least one of battery performance requirements of the user equipment, subscriber preferences of a subscriber identity corresponding to the user equipment, or application performance requirements of an application that is to be executed on the user equipment.

13. A method, comprising:
in response to determining that a user equipment has performed a call setup, corresponding to a data communication session, on a stand-alone radio access network equipment that comprises stand-alone network equipment communication capabilities and that is associated with a defined generation of deployment of network equipment, determining, by a system comprising a processor, user equipment communication capabilities corresponding to the user equipment, stand-alone network equipment communication capabilities of the stand-alone radio access network equipment, and non-stand-alone network equipment communication capabilities of a non-stand-alone radio access network equipment, wherein the non-stand-alone radio access network equipment is associated with the defined generation of deployment of network equipment and comprises non-stand-alone network equipment communication capabilities corresponding to a previously defined generation of deployment of network equipment, wherein the stand-alone network equipment communication capabilities comprise a first defined aggregated channel bandwidth corresponding to a first defined number of communication channels, wherein the non-stand-alone network equipment communication capabilities comprise a second defined aggregated channel bandwidth corresponding to a second defined number of communication channels, and wherein the second defined aggregated channel bandwidth is greater than the first defined aggregated channel bandwidth; and
based on the user equipment communication capabilities, the stand-alone network equipment communication capabilities, and the non-stand-alone network equipment communication capabilities, determining, by the system, whether a first estimate of a communication performance criterion corresponding to the second defined number of communication channels of the non-stand-alone radio access network equipment and a second estimate of the communication performance criterion corresponding to the first defined number of communication channels of the stand-alone radio access network equipment satisfy a defined condition with respect to initiating a handover of the communication session from the stand-alone radio access network equipment to the non-stand-alone radio access network equipment to facilitate providing, via the non-stand-alone radio access network equipment using the second defined number of communication channels, at least a portion of the communication session to the user equipment.

14. The method of claim 13, further comprising:
in response to the first estimate of the communication performance criterion and the second estimate of the communication performance criterion being determined to satisfy the defined condition with respect to initiating the handover, starting, by the system, a timer that has been set to expire after a defined period; and
in response to determining that the timer has expired, and, in response to determining that the communication session has not ended, initiating, by the system, the handover of the communication session from the stand-alone radio access network equipment to the non-stand-alone radio access network equipment.

15. The method of claim 14, further comprising:
in response to the communication session being determined to be completed, directing, by the system, the user equipment to camp on the stand-alone radio access network equipment.

16. The method of claim 13, further comprising:
in response to receiving, from the user equipment, a request to initiate the handover of the communication session from the stand-alone radio access network equipment to the non-stand-alone radio access network equipment, initiating, by the system, the handover of the communication session from the stand-alone radio access network equipment to the non-stand-alone radio access network equipment; and
in response to the communication session being determined to be completed via the non-stand-alone radio access network equipment, directing, by the system, the user equipment to camp on the stand-alone radio access network equipment.

17. A non-transitory machine-readable medium, comprising executable instructions that, when executed by a system comprising a processor, facilitate performance of operations, comprising:
in response to a user equipment being determined to be camped on a stand-alone radio access network equipment corresponding to a defined generation of wireless deployment of network equipment,
determining user equipment communication capabilities of the user equipment,
stand-alone radio access network equipment communication capabilities of the stand-alone radio access network equipment, and
non-stand-alone radio access network equipment communication capabilities of a non-stand-alone radio access network equipment corresponding to the defined generation of wireless deployment of network equipment, wherein the non-stand-alone radio access network equipment communication capabilities correspond to a previously defined generation of wireless deployment of network equipment comprising a first aggregated bandwidth of a first group of communication channels of the non-stand-alone radio access network equipment that is greater than a second aggregated bandwidth of a second group of communication channels of the stand-alone radio access network equipment; and
based on the user equipment communication capabilities, the stand-alone radio access network equipment communication capabilities, and the non-stand-alone radio access network equipment communication capabilities, determining whether to initiate a handover of a communication session from the stand-alone radio access network equipment to the non-stand-alone radio access network equipment to facilitate providing, via the non-stand-alone radio access network equipment using the first aggregated bandwidth of the first group of communication channels of the non-stand-alone radio access network equipment that is greater than the second aggregated bandwidth of the second group of communication channels of the stand-alone radio access network equipment, at least a portion of the communication session to the user equipment.

18. The non-transitory machine-readable medium of claim 17, wherein the operations further comprise:
in response to the handover being determined to be initiated, starting a timer that has been set to expire after a defined time interval;
in response to the timer being determined to expire after the defined time interval, and in response to the communication session being determined not to have ended, initiating the handover of the communication session; and
in response to the communication session being determined to be completed, directing the user equipment to camp on the stand-alone radio access network equipment.

19. The non-transitory machine-readable medium of claim 17, wherein determining whether to initiate the handover comprises:
in response to receiving, from the user equipment, a request to initiate the handover of the communication session from the stand-alone radio access network equipment to the non-stand-alone radio access network equipment, initiating the handover of the communication session from the stand-alone radio access network equipment to the non-stand-alone radio access network equipment.

20. The non-transitory machine-readable medium of claim 19, wherein the operations further comprise:
in response to the communication session being determined to be completed, directing the user equipment to camp on the stand-alone radio access network equipment.
